(19) United States
(12) Patent Application Publication
(10) Pub. No.: US 2024/0132735 A1
(43) Pub. Date: Apr. 25, 2024

(54) INK COMPOSITION FOR AQUEOUS BALLPOINT PEN

(71) Applicant: MITSUBISHI PENCIL COMPANY, LIMITED, Shinagawa-ku (JP)

(72) Inventors: Yuichi MIYAZAKI, Shinagawa-ku (JP); Satoshi UEDA, Shinagawa-ku (JP)

(73) Assignee: MITSUBISHI PENCIL COMPANY, LIMITED, Shinagawa-ku (JP)

(21) Appl. No.: 18/554,862

(22) PCT Filed: Mar. 23, 2022
(86) PCT No.: PCT/JP2022/013528

§ 371 Date: Oct. 11, 2023

(30) Foreign Application Priority Data
Apr. 20, 2021 (JP) 2021-071262

(51) Int. Cl. C09D 11/18

(52) U.S. Cl. CPC C09D 11/18

(57) ABSTRACT

A water-based ink composition for an aqueous ballpoint pen that maintains smooth writing feel even when stored for a long time with a pen tip facing downward and is excellent in suppressing abrasion of a ball receiving seat is provided. Such an ink composition for an aqueous ballpoint pen includes an ink composition for an aqueous ballpoint pen, the ink composition comprising at least a coloring material; fine particles having a new Mohs hardness of 3 or greater and an average particle size of 30 μm or less; a polyoxyethylene polycyclic phenyl-based surfactant; and a water-soluble solvent.

### TECHNICAL FIELD

The present specification relates to a water-based ink composition for an aqueous ballpoint pen, the water-based ink composition maintaining a smooth writing feel and being excellent in suppressing abrasion of a ball receiving seat even when stored for a long time with a pen tip facing downward.

### BACKGROUND ART

In a known ink composition for an aqueous ballpoint pen, examples of an ink composition capable of suppressing abrasion of a ball receiving seat due to rotation of a ball at the time of writing include:
1) an ink for an aqueous ballpoint pen, containing at least a pigment as a coloring material, fine particles having anew Mohs hardness of 4 or greater, and a liquid medium (see, for example, Patent Document 1);
2) a water-based ink composition for a fine ballpoint pen, containing at least water, a coloring agent, and a water-soluble solvent, wherein one type or two or more types of ultrafine particles having a particle size of less than 0.1 μm selected from the group consisting of alumina, titanium oxide, silica, silicon carbide, and tungsten carbide are blended, and the blending amount of the ultrafine particles is 0.002 to 2 wt % in the ink composition (see, for example, Patent Document 2).

However, the ink of Patent Document 1 has a problem that when it is stored for a long time with a pen tip facing downward, a coloring material, for example, a pigment is deposited on the pen tip, which results in an influence on abrasion of a ball receiving seat and an influence on the writing feel leading to stiff writing feel at the beginning of writing.

Although the water-based ink composition of Patent Document 2 is excellent in suppressing abrasion of a ball receiving seat, when the composition having the above-described formulation is stored with a pen tip facing downward for a long time, the writing feel and the effect of suppressing abrasion of the ball receiving seat is sometimes slightly insufficient.

On the other hand, examples of a technique of using a polyoxyethylene polycyclic phenyl-based surfactant in an ink for a writing material include: 3) a colored resin particle dispersion containing styrene-acrylonitrile resin particles, a coloring material, a specific dispersant such as a polyoxyethylene polycyclic phenyl-based surfactant, and water, and a water-based ink composition for a writing material containing the colored resin particle dispersion (see, for example, Patent Document 3) for providing a colored resin particle dispersion having excellent dispersion stability, and, an water-based ink composition for a writing material having excellent dispersion stability and capable of obtaining good handwriting; 4) an ink composition for an aqueous ballpoint pen containing a coloring agent, an acrylic acid copolymer, a specific dispersant such as a polyoxyethylene polycyclic phenyl-based surfactant, and water, and an aqueous ballpoint pen using the ink composition (see, for example, Patent Document 4) for providing an ink composition for a ballpoint pen capable of providing good handwriting in writing and having excellent dispersion stability of a coloring agent and storage stability of the ink composition.

Patent Documents 3 and 4 described above relate to ink compositions for a ballpoint pen having excellent dispersion stability of a coloring agent and excellent storage stability, but they do not suppress abrasion of a ball receiving seat, and do not recognize the problem of long-term storage with a pen tip facing downward when fine particles having a new Mohs hardness of 3 or greater are used. Patent Documents 3 and 4 are different from the present disclosure in the problems and technical ideas (configurations and operational effects) of the invention.

### CITATION LIST

### Patent Document

Patent Document 1: JP 2002-206066 A (Claims, Examples, etc.)
Patent Document 2: JP 2007-518838 A (Claims, Examples, etc.)
Patent Document 3: JP 2019-189802 A (Claims, Examples, etc.)
Patent Document 4: JP 2020-180198 A (Claims, Examples, etc.)

### SUMMARY OF INVENTION

### Technical Problem

The present disclosure has been made in view of the above problems and current state of the related art, and an object of the present disclosure is to provide a water-based ink composition for a ballpoint pen that maintains smooth writing feel and is excellent in suppressing abrasion of a ball receiving seat even when stored for a long time with a pen tip facing downward.

### Solution to Problem

As a result of dedicated research in light of the problems of the related art described above, the present inventors have found that the intended ink composition for an aqueous ballpoint pen is enabled when the ink composition contains at least a coloring material, fine particles having a specific physical property of a new Mohs hardness of 3 or greater, a polyoxyethylene polycyclic phenyl-based surfactant, and a water-soluble solvent, and the present inventors have completed the present disclosure.

That is, an ink composition for an aqueous ballpoint pen of the present disclosure contains at least a coloring material, fine particles having a new Mohs hardness of 3 or greater and an average particle size of 30 Tim or less, a polyoxyethylene polycyclic phenyl-based surfactant, and a water-soluble solvent.

A numerical value calculated by multiplying the new Mohs hardness of the fine particles by the average particle size (μm) of the fine particles is preferably 0.02 to 450.

The ink composition preferably contains 0.001 to 5 mass % of the fine particles with respect to the total amount of the ink composition.

The polyoxyethylene polycyclic phenyl-based surfactant is preferably polyoxyethylene distyrenated phenyl ether.

The ink composition preferably contains 0.05 to 20 mass % of the polyoxyethylene polycyclic phenyl-based surfactant with respect to the total amount of the ink composition.

The ink composition preferably has a viscosity of 50 to 2000 mPa·s (25° C.) as measured with a cone-plate type rotational viscometer (1° 34′ R24 cone) at 1 rpm.

### Advantageous Effects of Invention

According to the present disclosure, there are provided a water-based ink composition for an aqueous ballpoint pen that maintains smooth writing feel and is excellent in suppressing abrasion of a ball receiving seat even when stored for a long time with a pen tip facing downward, and an aqueous ballpoint pen equipped with the ink composition.

The object and effects of the present disclosure can be recognized and obtained especially using the components and combinations indicated in the claims. Both general explanation described above and detailed explanation described below are exemplary and explanatory and do not limit the present disclosure described in Claims.

### DESCRIPTION OF EMBODIMENTS

Hereinafter, embodiments of the present disclosure will be described in detail. Note that the technical scope of the present disclosure is not limited to the embodiment described below but includes the invention described in Claims and equivalents thereof.

The ink composition for an aqueous ballpoint pen of the present disclosure contains at least a coloring material, fine particles having a new Mohs hardness of 3 or greater and an average particle size of 30 μm or less, a polyoxyethylene polycyclic phenyl-based surfactant, and a water-soluble solvent.

As the coloring material to be used in the present disclosure, all dyes dissolved or dispersed in water, known inorganic or organic pigment systems such as titanium oxide, resin particle pigments containing a pigment, pseudo pigments produced by coloring a resin emulsion with a dye, white plastic pigments, wax particles, hollow resin particles, pigments including silica or mica as a base material with multi-layer coating of iron oxide, titanium oxide, or the like as surface layers, thermochromic pigments, photochromic particles, and the like, and composite particles of these materials can be used without limitation.

Examples of the dye include: acid dyes such as Eosin, Phloxine, Water Yellow #6-C, Acid Red, Water Blue #105, Brilliant Blue FCF, and Nigrosine NB; direct dyes such as Direct Black 154, Direct Sky Blue 5B, and Violet BB; and basic dyes such as rhodamine and methyl violet.

Examples of the inorganic pigment include azo lake, insoluble azo pigments, chelate azo pigments, phthalocyanine pigments, perylene or perinone pigments, and nitroso pigments. More specific examples of the inorganic pigment include inorganic pigments such as carbon black, titanium black, zinc white, red iron oxide, aluminum, chrome oxide, iron black, cobalt blue, yellow iron oxide, viridian, zinc sulfide, lithopone, cadmium yellow, vermilion, cadmium red, chrome yellow, molybdate orange, zinc chromate, strontium chromate, white carbon, clay, talc, ultramarine, precipitated barium sulfate, baryta powder, calcium carbonate, lead white, navy white, iron blue, manganese violet, aluminum powder, and brass powder, C. I. Pigment Blue 17, C.I. Pigment Blue 15, C.I. Pigment Blue 17, C.I. Pigment Blue 27, C.I. Pigment Red 5, C.I. Pigment Red 22, C.I. Pigment Red 38, C.I. Pigment Red 48, C.I. Pigment Red 49, C.I. Pigment Red 53, C.I. Pigment Red 57, C.I. Pigment Red 81, C.I. Pigment Red 104, C.I. Pigment Red 146, C.I. Pigment Red 245, C.I. Pigment Yellow 1, C.I. Pigment Yellow 3, C.I. Pigment Yellow 12, C.I. Pigment Yellow 13, C.I. Pigment Yellow 14, C.I. Pigment Yellow 17, C.I. Pigment Yellow 34, C.I. Pigment Yellow 55, C.I. Pigment Yellow 74, C.I. Pigment Yellow 95, C.I. Pigment Yellow 166, C.I. Pigment Yellow 167, C.I. Pigment Orange 5, C.I. Pigment Orange 13, C.I. Pigment Orange 16, C.I. Pigment Violet 1, C.I. Pigment Violet 3, C.I. Pigment Violet 19, C.I. Pigment Violet 23, C.I. Pigment Violet 50, and C.I. Pigment Green 7.

An example of the thermochromic pigment includes a thermochromic pigment produced by microencapsulating a thermochromic composition containing at least a leuco dye functioning as a color former, a color developer serving as a component capable of developing a color of the leuco dye, and a discoloration temperature adjusting agent capable of controlling a discoloration temperature in coloring of the leuco dye and the color developer such that the thermochromic composition has a predetermined average particle size (for example, 0.1 to 6 μm).

Examples of the photochromic particles include photochromic particles composed of at least one or more types selected from the group consisting of photochromic colorant (compound) and fluorescent colorant, and a resin such as a terpene phenol resin; and photochromic particles produced by microencapsulating a photochromic composition containing at least one or more types selected from the group consisting of photochromic colorant (compound), fluorescent colorant, an organic solvent, and an additive such as an antioxidant, a light stabilizer, or a sensitizer to have a predetermined average particle size (for example, 0.1 to 6 μm).

In the present disclosure (including Examples, etc.), “average particle size” is a value of D50 measured with a particle size analyzer [MICROTRAC HRA9320-X100 (available from Nikkiso Co., Ltd.)].

Examples of the method for microencapsulating the thermochromic pigment include interfacial polymerization, interfacial polycondensation, in situ polymerization, in-liquid curing coating, phase separation from an aqueous solution, phase separation from an organic solvent, melt dispersion cooling, air suspension coating, and spray drying. The method may be selected as appropriate according to the intended use. For example, in the phase separation from an aqueous solution, a leuco dye, a developer, and a discoloration temperature adjusting agent are melted by heating, added to an emulsifier solution, and dispersed in the form of oil droplets under heating and stirring. Subsequently, as a capsule membrane material, a resin raw material having a wall membrane of, for example, an urethane resin, an epoxy resin, or an amino resin, such as an amino resin solution, specifically, a methylol melamine aqueous solution, an urea solution, or a benzoguanamine solution, is added gradually, and the mixture is allowed to react continuously to prepare a dispersion, and then the dispersion is filtered, whereby a thermochromic microcapsule pigment can be produced. In this thermochromic pigment, the coloring and decoloring temperatures of each color can be set to appropriate temperatures by appropriately combining the types and amounts of the leuco dye, the developer, and the discoloration temperature adjusting agent.

Microencapsulation of the photochromic particles may be performed in the same manner as in the above-described preparation of the thermochromic resin particles.

The photochromic particles can be made colorless in an indoor lighting environment (indoor lighting equipment selected from the group consisting of incandescent light, fluorescent light, lamps, white LED, and the like) and develop a color in an environment under UV irradiation (an environment under irradiation with a wavelength at 200 to 400 nm, or sunlight including UV) through the appropriate use of dyes such as photochromic dyes (compounds) and fluorescent dyes.

These coloring materials may be used alone or in a combination of two or more. Among these coloring materials, the average particle size of pigments dispersed in water, resin particle pigments, pseudo pigments, white plastic pigments, multilayer-coated pigments, thermochromic pigments, photochromic particles, and the like varies depending on the ball diameter, ink composition, viscosity, and the like, but the average particle size is preferably 0.02 to 6 μm.

The content of these coloring materials can be appropriately increased or decreased depending on the drawn line density of the ink, but is desirably 0.1 to 40 mass % (hereinafter, “mass %” is referred to as “o”), preferably 1 to 10%, with respect to the total amount of the ink composition.

The fine particles having a new Mohs hardness of 3 or greater and an average particle size of 30 μm or less used in the present disclosure are contained to exhibit an effect of suppressing abrasion of a ball receiving seat. The fine particles to be used are not particularly limited as long as they have a new Mohs hardness of 3 or greater and an average particle size of 30 μm or less.

The new Mohs hardness is synonymous with the modified Mohs hardness. The new Mohs hardness is a measure of the hardness of a mineral measured by comparing the mineral with 15 types of reference minerals. The reference minerals are, in order from soft one (new Mohs hardness 1) to hard one (new Mohs hardness 15), talc, gypsum, calcite, fluorite, apatite, orthoclase, fused silica, crystal (quartz), topaz, garnet, fused zirconia, fused alumina, silicon carbide, boron carbide, and diamond. In the present specification, the new Mohs hardness is measured by scratching a sample substance (fine particles) whose hardness is to be measured with the reference minerals and determining the presence or absence of scratches. For example, when a scratch is not formed with calcite but formed with fluorite, the new Mohs hardness of the sample material (fine particles) is 3.5 (meaning in-between 3 and 4). Fine particles having anew Mohs hardness less than 3 are not preferable because it is difficult to achieve a sufficient effect of suppressing abrasion of a receiving seat and the effect of the present disclosure cannot be exhibited.

When fine particles having a new Mohs hardness of 3 or greater are used, the ink flows out with the rotation of a ball at the time of writing, and at the same time, the fine particles are embedded in a ball receiving seat by a large pressure at the time of writing, and as a result, the surface hardness of the receiving seat increases, which suppresses abrasion of the receiving seat accompanying the rotation of the ball. Preferably, the new Mohs hardness of the fine particles is 3 or greater and 15 or less from the viewpoint of durability and ink outflow properties.

Examples of the fine particles having a new Mohs hardness of 3 or greater and 15 or less include ceramic fine particles, metal fine particles, and resin fine particles, such as silicon carbide, alumina, silica, tungsten carbide, titanium oxide, and melamine resin, and these can be used alone or in combination of two or more.

The fine particles to be used have an average particle size of 30 μm or less, preferably 0.007 to 30 μm, more preferably 0.01 to 10 μm, from the viewpoint of further reducing abrasion of a receiving seat and dispersibility in the ink. When fine particles having an average particle size exceeding 30 μm are used, the dispersion stability in the ink and the reduction of sedimentation of the fine particles deteriorate, which is not preferable.

The shapes of the fine particles having the predetermined new Mohs hardness and average particle size are preferably spherical, elliptical, plate-like shape, or rod-like shape from the viewpoint of improvement in writing feel and ink outflow properties.

As these fine particles, commercially available fine particles can be used as long as they have the above-described predetermined new Mohs hardness and average particle size, and ceramic fine particles, metal fine particles, resin fine particles, and the like produced by known methods can be used. Further, in the present disclosure, when the fine particles satisfying the above-described new Mohs hardness and having a numerical value (hereinafter referred to as a “multiplied value”) calculated by multiplying the new Mohs hardness of the fine particles by the average particle size (μm) thereof within a predetermined range is used in an ink composition for an aqueous ballpoint pen, both reduction of abrasion of a receiving seat and dispersion stability are achieved at a high level, and the effect of the present disclosure can be more suitably exhibited. The predetermined range of the multiplied value is preferably 0.02 to 450, more preferably 0.03 to 150.

The content of the fine particles having the predetermined new Mohs hardness and average particle size is preferably 0.001 to 5%, more preferably 0.1 to 2%, with respect to the total amount of the ink composition.

When the content of the fine particles is less than 0.001%, sufficient reduction of abrasion of a receiving seat cannot be achieved, and on the other hand, when the content is more than 5%, the writing feel may degrade.

The polyoxyethylene polycyclic phenyl-based surfactant used in the present disclosure is an ether having “a group having at least two monocyclic aromatic hydrocarbon groups (for example, a phenyl group, a phenylene group, etc.)” or “a group having at least one polycyclic aromatic hydrocarbon group (for example, a naphthyl group, etc.)” in the molecular skeleton.

The polyoxyethylene polycyclic phenyl-based surfactant is a component responsible for good dispersion stability even in long-team storage of the fine particles having the above physical properties, and examples thereof include a compound represented by the following Formula (1).

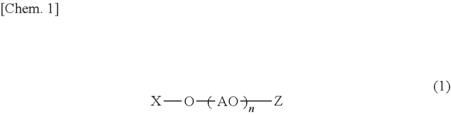

[In Formula (1), X is a polycyclic phenyl group; AO is an alkyleneoxy group having 2 to 5 carbon atoms; Z is SO₃M or a hydrogen atom, and M is a hydrogen atom or an organic or inorganic cation; and n is a number of 3 to 120.]

In Formula (1), X is a polycyclic phenyl group. The “polycyclic phenyl group” is “a group having at least two monocyclic aromatic hydrocarbon groups (for example, phenyl group, phenylene group, etc.)” or “a group having at least one polycyclic aromatic hydrocarbon group (specifically, a group resulting from condensation of at least two benzene rings, for example, naphthyl group, phenanthryl group, etc.)”. Examples of the “polycyclic phenyl group” in Formula (1) include the following Formulas (2) to (5).

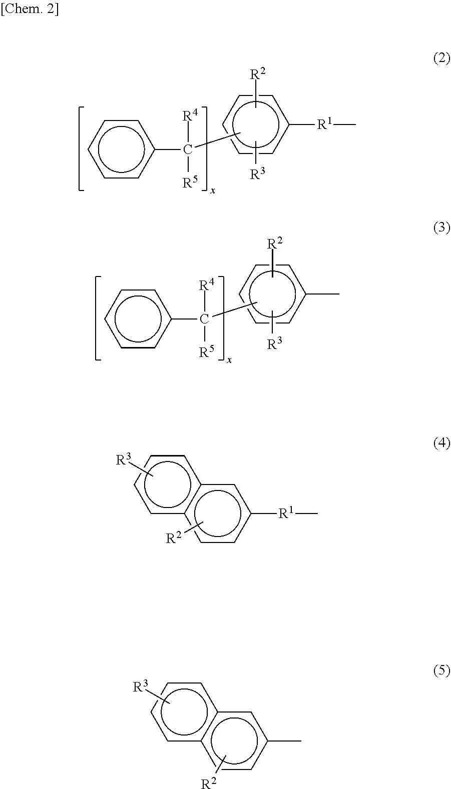

[In Formulas (2) to (5), R¹ is a chain hydrocarbon group having 1 to 3 carbon atoms. R² and R³ are independently a hydrogen atom or a chain hydrocarbon group having 1 to 3 carbon atoms, or a group represented by Formula (6). R⁴ and R⁵ are independently a hydrogen atom or a chain hydrocarbon group having 1 to 3 carbon atoms. x is an integer of 1 to 3.]

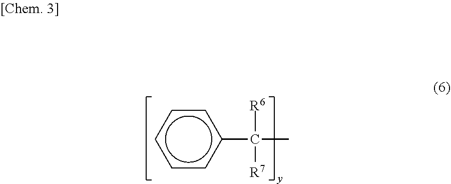

[In Formula (6), R⁶ and R⁷ are independently a hydrogen atom or a chain hydrocarbon group having 1 to 3 carbon atoms, and y represents an integer of 1 to 3.]

The polyoxyethylene polycyclic phenyl-based surfactant used in the present disclosure may contain a bisphenol-based polycyclic group represented by Formula (7) or (8).

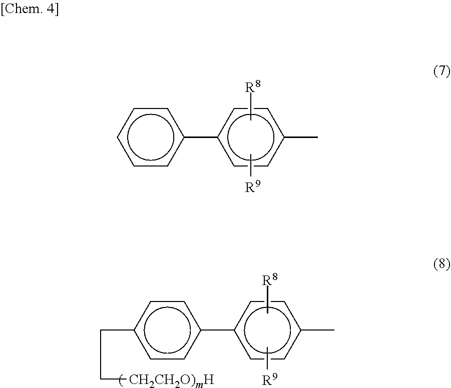

[In Formulas (7) and (8), R⁸ and R⁹ are each independently a hydrogen atom or a chain hydrocarbon group having 1 to 3 carbon atoms, and m is an integer satisfying m≥2.]

In Formula (1), X is preferably a distyrenated phenyl group, a distyrenated methylphenyl group, or a tristyrenated phenyl group.

In Formula (1), Z represents SO₃M or a hydrogen atom, and M represents a hydrogen atom or an organic or inorganic cation, preferably a hydrogen atom. Examples of the cation represented by M include an alkali metal ion, an alkaline earth metal ion, an ammonium ion, and an alkyl-substituted ammonium ion.

In the Formula (1), n is preferably 3 to 120, more preferably 3 to 20, and particularly preferably 3 to 10. When the upper value and the lower value are within the above ranges, both the stability of the ink composition for an aqueous ballpoint pen and the dispersion stability of the fine particles having the above properties can be achieved at a high level. The production of the polyoxyethylene polycyclic phenyl-based surfactant is known, and for example, the polyoxyethylene polycyclic phenyl-based surfactant is produced by formalin condensation of distyrenated phenol in the presence of formaldehyde to produce a bis form, and then addition polymerization of ethylene oxide to the product in the presence of a catalyst.

In the present disclosure, the length of the ethylene oxide moiety in the polyoxyethylene polycyclic phenyl-based surfactant is preferably such that the number of moles of ethylene oxide added is 10 to 120 from the viewpoint of further exhibiting the effect of the present disclosure. In particular, the number of moles of ethylene oxide added is preferably 20 or greater. Examples of preferable polyoxyethylene polycyclic phenyl-based surfactant include polyoxyethylene distyrenated phenyl ether, polyoxyethylene distyrenated methyl phenyl ether, polyoxyethylene distyrenated methyl phenyl ether sulfate, polyoxyethylene tristyrenated phenyl ether, polyoxyethylene tribenzyl phenyl ether, polyoxyethylene distyrenated cresyl ether, and polyoxyethylene allyl phenyl ether, and polyoxyethylene distyrenated phenyl ether is particularly preferable.

Specific examples of the polyoxyethylene polycyclic phenyl-based surfactant include EMULGEN A-60, EMULGEN A-90, EMULGEN A-500, EMULGEN B-66 (Kao Corporation), Newcol 703, Newcol 704, Newcol 706, Newcol 707, Newcol 708, Newcol 709, Newcol 710, Newcol 711, Newcol 712, Newcol 714, Newcol 719, Newcol 723, Newcol 729, Newcol 733, Newcol 740, Newcol 747, Newcol 780, Newcol 610, Newcol 2604, Newcol 2607, Newcol 2609, Newcol 2614 (Nippon Nyukazai Co., Ltd.), NOIGEN EA-87, NOIGEN EA-137, NOIGEN EA-157, NOIGEN EA-167, NOIGEN EA-177, NOIGEN EA-197D, and NOIGEN EA-207D (DKS Co. Ltd.).

These polyoxyethylene polycyclic phenyl-based surfactants can be used alone or in combination of two or more thereof.

The content of these polyoxyethylene polycyclic phenyl-based surfactants varies depending on the type and amount of the fine particles and the type and amount of the coloring materials, but the content is 0.05 to 20%, preferably 1 to 10% with respect to the total amount of the ink composition. When the content is less than 0.05% with respect to the total amount of the ink composition, the stability over time of the fine particles of the above properties degrades, and when the content is more than 20%, the ink viscosity increases, the ink outflow properties decrease, and the writing line quality degrades, which are not preferable.

In the present disclosure, the mass ratio represented by “Content of fine particles (A) having the above physical properties/content of polyoxyethylene polycyclic phenyl-based surfactant (B)” (hereinafter, the ratio may be referred to as (A)/(B) ratio) is preferably 0.005 to 10.0, and more preferably 0.05 to 1.5. When the lower value and the upper value of the (A)/(B) ratio are within the above ranges, the abrasion resistance of the ink composition for an aqueous ballpoint pen further improves, and a smoother and more stable writing feel can be realized.

The water-soluble solvent used in the present disclosure is used for various qualities as ink, for example, ink freezing prevention at a low temperature, ink drying prevention at a pen tip, and the like. Specific examples of the water-soluble solvent include glycols such as ethylene glycol, diethylene glycol, triethylene glycol, propylene glycol, polyethylene glycol, 3-butylene glycol, thiodiethylene glycol, and glycerin, ethylene glycol monomethyl ether, and diethylene glycol monomethyl ether. These solvents may be used alone or in combination. The content of the water-soluble solvent is desirably 1 to 40% with respect to the total amount of the ink composition.

The ink composition for an aqueous ballpoint pen of the present disclosure contains at least the coloring material, the fine particles having a new Mohs hardness of 3 or greater and an average particle size of 30 μm or less, the polyoxyethylene polycyclic phenyl-based surfactant, and the water-soluble solvent. In addition, the ink composition for an aqueous ballpoint pen of the present disclosure may contain, as necessary, a dispersant, a water-soluble resin, a lubricant, a thickener, a pH adjuster, a rust inhibitor, a preservative, a bacteriostatic agent, or the like in addition to water (tap water, purified water, distilled water, ion-exchanged water, pure water, or the like) as a solvent as a balance as long as the effect of the present disclosure is not impaired.

Examples of the dispersant that can be used include nonionic and anionic surfactants other than the polyoxyethylene polycyclic phenyl-based surfactant.

The water-soluble resin can be suitably used from the viewpoint of adjusting the viscosity and improving the fixing strength, and specific examples thereof include at least one type selected from the group consisting of water-soluble resins having a hydrophobic part in the molecule such as polyacrylic acid, water-soluble styrene-acrylic resin, water-soluble styrene-maleic acid resin, polyvinyl alcohol, polyvinyl pyrrolidone, water-soluble maleic acid resin, water-soluble styrene resin, polyvinyl pyrrolidone, polyvinyl alcohol, water-soluble ester-acrylic resin, ethylene-maleic acid copolymer, polyethylene oxide, and water-soluble urethane resin, and resin emulsions such as polyolefin-based emulsion, acrylic emulsion, vinyl acetate-based emulsion, urethane-based emulsion, styrene-butadiene emulsion and styrene-acrylonitrile emulsion and the like, and it is desirable to use two or more of them in total, one or more of them for each.

Examples of the lubricant that can be used include non-ionic types such as fatty acid esters of polyhydric alcohols, higher fatty acid esters of sugars, polyoxyalkylene higher fatty acid esters, and alkyl phosphate esters; anionic types such as phosphate, alkyl sulfonates of higher fatty acid amides, and alkyl allyl sulfonates; derivatives of polyalkylene glycols, and polyether modified silicones, which are also used as surface treating agents for pigments.

As the thickener that can be used, a known thickener can be used, and specifically, at least one type selected from the group consisting of alkali swelling and association type emulsion, alkali swelling type emulsion, polyvinyl pyrrolidone, cellulose derivative, polysaccharides such as xanthan gum and succinoglycan, and inorganic thickeners such as crosslinked acrylic acid polymers, crystalline cellulose, leozan gum, gellan gum, and montmorillonite clay mineral.

Examples of the pH adjuster include ammonia, urea, monoethanolamine, diethanolamine, triethanolamine, alkali metal salts of carbonic acid and phosphoric acid such as sodium tripolyphosphate and sodium carbonate, and hydrates of alkali metals such as sodium hydroxide. Furthermore, examples of the corrosion inhibitor include benzotriazole, tolyltriazole, dicyclohexylammonium nitrite, and saponins. Examples of the preservative or antibacterial agent include phenol, sodium omadine, sodium benzoate, thiazoline-based compounds, and benzimidazole compounds.

For the components, such as the dispersant, the lubricant, the thickener, the pH adjuster, the corrosion inhibitor, the preservative, or the antibacterial agent, one type may be used alone, or a combination of two or more types of these may be used. Commercially available products of these, if present, can be used.

The ink composition for an aqueous ballpoint pen of the present disclosure can be produced by production methods of other water-based ink compositions without a particular difference.

That is, the ink composition for an aqueous ballpoint pen of the present disclosure can be produced by mixing and stirring at least a coloring material, fine particles having a new Mohs hardness of 3 or greater and an average particle size of 30 Tim or less, a polyoxyethylene polycyclic phenyl-based surfactant, a water-soluble solvent, and other components with a mixer or the like, for example, a bead mill, a homomixer, a homogenizer, or the like capable of applying strong shear under stirring conditions set to suitable conditions, and removing coarse particles in the ink composition by filtration or centrifugation as necessary.

In addition, a pH level (at 25° C.) of the ink composition for an aqueous ballpoint pen of the present disclosure is adjusted to preferably 5 to 10, more preferably 6 to 9.5, by using a pH adjuster or the like from the perspective of usability, safety, stability of the ink itself, and matching with the ink container.

The viscosity of the ink composition for an aqueous ballpoint pen of the present disclosure is desirably 50 to 2000 mPa·s (25° C.), preferably 100 to 1000 mPa·s at 1 rpm as measured with a cone-plate type rotational viscometer (1° 34′ R24 cone).

When the viscosity is less than 50 mPa·s (25° C.), fine particles having the above properties are likely to settle, clogging of a pen tip is likely to occur, and the initial writing property may deteriorate. When the viscosity exceeds 2000 mPa 5 (25° C.), the outflow properties may decrease, and the writing feel may deteriorate.

The ink composition for an aqueous ballpoint pen of the present disclosure is loaded in a ballpoint pen provided with a pen tip portion such as a ballpoint pen tip.

An example of the aqueous ballpoint pen of the present disclosure includes a ballpoint pen where, in an ink container (refill) for an aqueous ballpoint pen having a ball with a diameter of 0.18 to 2.0 mm, accommodated are the ink composition for a ballpoint pen having the above-mentioned composition and, as an ink follower, a material that is not compatible with the water-based ink composition accommodated in the ink container and has a smaller specific gravity than the water-based ink composition, for example, polybutene, silicone oil, or mineral oil. As long as a ball having the diameter in the range described above is included, the structure of the ballpoint pen to be used is not particularly limited. In particular, preferred is an aqueous ballpoint pen with a refill in which the water-based ink composition is filled in an ink container, which is a polypropylene resin tube, the ballpoint pen having a stainless steel tip at the tip (the ball is made of cemented carbide).

Furthermore, the ballpoint pen may be a direct liquid type ballpoint pen having a collector structure (ink retention mechanism) in which a shaft cylinder itself is used as an ink container and thus is filled with the ink composition for an aqueous ballpoint pen having the composition described above.

In the present disclosure, in particular, when used in an aqueous ballpoint pen having a ball with a diameter of 0.18 to 2.0 mm, reduction of abrasion of a receiving seat is expected, which is preferable.

An action mechanism that the ink composition for an aqueous ballpoint pen of the present disclosure thus configured and an aqueous ballpoint pen equipped with the ink composition maintain smooth writing feel and are excellent in suppressing abrasion of a ball receiving seat even when stored for a long time with a pen tip facing downward is presumed as below. That is, since fine particles having a new Mohs hardness of 3 or greater and an average particle size of 30 μm or less and a polyoxyethylene polycyclic phenyl-based surfactant are contained in an ink composition for an aqueous ballpoint pen containing at least a coloring material, the ink physical properties do not change during long-team storage, and an ink having good stability flows out with the rotation of a ball at the time of writing. At the same time, as the fine particles having the above properties are embedded in a ball receiving seat by the pressure at the time of writing, and as a result, the surface hardness of the receiving seat increases, the abrasion of the receiving seat caused by the rotation of the ball is reduced. Even in a state of long-term storage, the fine particles of the above properties and the coloring material are uniformly and stably present in the ink interposed between the ball receiving seat and the ball at the time of writing, the rotation of the ball and the ink properties are not interrupted, and thus, the ink composition for an aqueous ballpoint pen of the present disclosure stably suppresses abrasion of the ball receiving seat, and provides a smooth and stable writing feel without impairing other writing performance.

The ink composition for an aqueous ballpoint pen of the present disclosure and an aqueous ballpoint pen equipped with the ink composition are extremely excellent in the long-lasting effect for exhibiting the effect of the present disclosure, having a long period of expression and long duration of the effect, and are excellent in stability over time because the ink composition is water-based composition.

### EXAMPLES

Next, the present disclosure will be described in more detail with reference to Examples 1 to 10 and Comparative Examples 1 to 5 of an ink composition for an aqueous ballpoint pen and an aqueous ballpoint pen equipped with the ink composition, but the present disclosure is not limited to the following Examples and the like.

### Examples 1 to 10 and Comparative Examples 1 to 5

According to the formulations shown in the following Table 1, each ink composition for an aqueous ballpoint pen was prepared by a common method. For each of the prepared ink compositions for an aqueous ballpoint pen (total amount: 100 mass %), the viscosity at 1 rpm was measured with a cone-plate type rotational viscometer (1° 34′ R24 cone) by the following methods, and evaluation was performed with an abrasion resistance test and for writing feel by the following methods.

These results are shown in Table 1 below.

Method for Measuring Viscosity of Ink Composition

The viscosity was measured at a rotational speed of 1 rpm using a cone-plate type rotational viscometer EMD manufactured by Tokimec Co., Ltd. at 25° C. with an ST rotor (1° 34′ R24 cone).

Ballpoint pen tips having a corresponding ball diameter (0.38 mm superalloy ball or 0.5 mm superalloy ball) were each equipped on a tube for UM-151 or UMN-105 manufactured by Mitsubishi Pencil Company, Limited (both made of PP having an inner diameter of 3.4 mm) and a polypropylene joint member. A water-based ink composition prepared in any one of Examples and Comparative Examples was filled therein, polybutene was filled as an ink follower, defoaming was performed by a centrifugal treatment (500 G, 5 min). And then, the aqueous ballpoint pens having the corresponding ball diameter were assembled, and the following various writing tests (abrasion resistance test, writing feel test) were performed.

A drawing test was performed by the following manner on the ballpoint pen stored for 12 weeks under the conditions of a temperature of 50° C. and a humidity of 65% with the pen tip facing downward. The evaluation test was performed with five ballpoint pens on each of ball diameters.

1) Abrasion resistance test: a 1000 m spiral drawing (end of a pen stroke) was performed in machine drawing test, and the result was evaluated according to the following evaluation criteria.

Drawing conditions: 100 gf, drawing angle: 75 degrees, drawing rate: 4.5 mm/min

Evaluation criteria:
A: All the pens were capable of writing with no problems.
B: Drawing was possible till the end of a pen stroke while some slight line breaks were observed.
C: Drawing was possible till the end of a pen stroke while some line breaks were observed.
D: One or more of the pens did not provide good flow.

2) Method for Evaluating Writing Feel

Using each of the aqueous ballpoint pens prepared above, freehand “spiral drawing” was performed on a writing paper, and the writing feel was evaluated according to the following evaluation criteria.

Evaluation criteria:
A: Smooth and stable writing feel.
B: Relatively rough and hard writing feel.
C: Rough and hard writing feel with slight line breaks and anisotropy.
D: Stiff and hard writing with remarkable line breaks and anisotropy.

(Total amount: 100 mass %)

| | | Examples | | | | | | | | | | Comparative Examples | | | | |
|---|---|---|---|---|---|---|---|---|---|---|---|---|---|---|---|---|
| | | 1 | 2 | 3 | 4 | 5 | 6 | 7 | 8 | 9 | 10 | 1 | 2 | 3 | 4 | 5 |
| Colorant | Carbon black MCF- | 5 | 5 | 5 | | | | | | | | 5 | | | 5 | |
| | 88 (pigment) *1 | | | | | | | | | | | | | | | |
| | Red 105 (dye) | | | | 6 | 6 | 6 | | | | | | 6 | | | |
| | Colored resin | | | | | | | 15 | 15 | | | | | 15 | | |
| | particle *2 | | | | | | | | | | | | | | | |
| | Thermochromic | | | | | | | | | 15 | 15 | | | | | 15 |
| | pigment *3 | | | | | | | | | | | | | | | |
| Fine | Fine particles 1 *4 | 0.5 | | | | | | 0.7 | | | | 2 | | | | |
| particles | Fine particles 2 *5 | | 1 | | 1 | | | | 1.2 | | | | 1.5 | | | |
| | Fine particles 3 *6 | | | 0.8 | | 0.8 | | | | 1 | | | | 0.5 | | |
| | Fine particles 4 *7 | | | | | | 2 | | | | 0.5 | | | | | |
| Polyoxy | Polyoxyethylene | 2 | | | 2 | | | 2 | | | | | | | 2 | |
| ethylene | tribenzyl phenyl | | | | | | | | | | | | | | | |
| polycyclic | ether *8 | | | | | | | | | | | | | | | |
| phenyl- | Polyoxyethylene | | 2 | | | 2 | | | 2 | 2 | | | | | | |
| based | distyrenated | | | | | | | | | | | | | | | |
| surfactant | phenyl ether | | | | | | | | | | | | | | | |
| | Polyoxyethylene | | | 2 | | | 2 | | | | 2 | | | | | 2 |
| | styrenated phenyl | | | | | | | | | | | | | | | |
| | ether *9 | | | | | | | | | | | | | | | |
| Water- | Styrene-acrylic | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| soluble | acid copolymer salt | | | | | | | | | | | | | | | |
| resin | | | | | | | | | | | | | | | | |
| Thickener | Xanthan gum | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| pH | Triethanolamine | 2 | 2 | 2 | 2 | 2 | 2 | 2 | 2 | 2 | 2 | 2 | 2 | 2 | 2 | 2 |
| Modifier | | | | | | | | | | | | | | | | |
| Corrosion | Benzotriazol | 0.3 | 0.3 | 0.3 | 0.3 | 0.3 | 0.3 | 0.3 | 0.3 | 0.3 | 0.3 | 0.3 | 0.3 | 0.3 | 0.3 | 0.3 |
| inhibitor | | | | | | | | | | | | | | | | |
| Preservative | Benzisothiazoline | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| Lubricant | Phosphate | 0.6 | 0.6 | 0.6 | 0.6 | 0.6 | 0.6 | 0.6 | 0.6 | 0.6 | 0.6 | 0.6 | 0.6 | 0.6 | 0.6 | 0.6 |
| Organic | Propylene glycol | 15 | 15 | 15 | 15 | 15 | 15 | 15 | 15 | 15 | 15 | 15 | 15 | 15 | 15 | 15 |
| solvent | | | | | | | | | | | | | | | | |
| Water | Distilled water | 73.9 | 73.4 | 73.6 | 72.4 | 72.6 | 71.4 | 63.7 | 63.2 | 63.4 | 63.9 | 74.4 | 73.9 | 65.9 | 74.4 | 64.4 |

| | | | | | | | | | | | | | | | |
|---|---|---|---|---|---|---|---|---|---|---|---|---|---|---|---|
| Viscosity at 1 rpm (25° C.: mPa | 600 | 750 | 550 | 490 | 760 | 330 | 1020 | 290 | 450 | 1000 | 640 | 580 | 730 | 560 | 700 |
| Abrasion resistance *10 | A/A | A/A | A/A | A/A | A/A | A/A | A/A | A/A | A/A | A/A | D/D | D/D | C/C | D/D | C/D |
| Writing feel *11 | A/A | A/A | A/A | A/A | A/A | A/A | A/A | A/A | A/A | A/A | D/D | C/C | D/D | D/D | D/C |

*4 Silicon carbide, new Mohs hardness of 13, average particle size of 2 μm, multiplied value: 26
*5 Alumina, new Mohs hardness of 12, average particle size of 0.05 μm, multiplied value: 0.6
*6 Silica, new Mohs hardness of 7, average particle size of 0.5 μm, multiplied value: 3.5
*7 Melamine resin, new Mohs hardness of 4, average particle size of 3 μm, multiplied value: 12
*8 EMULGEN B-66 (manufactured by Kao Corporation)
*9 NOIGEN EA series (manufactured by DKS Co. Ltd.)
*10 Ball diameter 0.38 mm/ball diameter 0.5 mm
*11 Ball diameter 0.38 mm/ball diameter 0.5 mm
*1 to *3 in Table 1 above are as described below.
*1: manufactured by Mitsubishi Chemical Corporation, average particle size 0.1 μm
*2: blue colored resin particle, average particle size 1.2 μm
*3: red thermochromic pigment, average particle size 3.0 μm, decoloring temperature 60° C.

As is clear from the results in Table 1 above, it was found that the two kinds of aqueous ballpoint pens with different ball diameters equipped with the ink composition for an aqueous ballpoint pen of Examples 1 to 10, which fall within the scope of the present disclosure, achieved both excellent abrasion resistance and writing feel at a high level even after long-team storage, as compared with Comparative Examples 1 to 5, which fall outside the scope of the present disclosure.

### INDUSTRIAL APPLICABILITY

An ink composition suitable for aqueous ballpoint pens is provided.

1. An ink composition for an aqueous ballpoint pen, the ink composition comprising:
at least a coloring material;
fine particles having a new Mohs hardness of 3 or greater and an average particle size of 30 μm or less;
a polyoxyethylene polycyclic phenyl-based surfactant; and
a water-soluble solvent.

2. The ink composition for an aqueous ballpoint pen according to claim 1, wherein a numerical value calculated by multiplying the new Mohs hardness of the fine particles by the average particle size (μm) of the fine particles is 0.02 to 450.

3. The ink composition for an aqueous ballpoint pen according to claim 1, wherein the ink composition contains 0.001 to 5 mass % of the fine particles with respect to the total amount of the ink composition.

4. The ink composition for an aqueous ballpoint pen according to claim 1, wherein the polyoxyethylene polycyclic phenyl-based surfactant is polyoxyethylene distyrenated phenyl ether.

5. The ink composition for an aqueous ballpoint pen according to claim 1, wherein the ink composition contains 0.05 to 20 mass % of the polyoxyethylene polycyclic phenyl-based surfactant with respect to the total amount of the ink composition.

6. The ink composition for an aqueous ballpoint pen according to claim 1, wherein the ink composition has a viscosity of 50 to 2000 mPa·s (25° C.) at 1 rpm as measured with a cone-plate type rotational viscometer (1′34′ R24 cone).
